(19) United States
(12) Patent Application Publication
(10) Pub. No.: US 2004/0209159 A1
(43) Pub. Date: Oct. 21, 2004

(54) Negative electrode for lithium battery, method of preparing same, and lithium battery comprising same

(75) Inventors: Jong-Ki Lee, Seoul (KR); Jea-Woan Lee, Yongin-city (KR); Chung-Kun Cho, Suwon-city (KR); Sang-Mock Lee, Suwon-City (KR)

Correspondence Address: STAAS & HALSEY LLP, SUITE 700, 1201 NEW YORK AVENUE, N.W., WASHINGTON, DC, 20005, US

(73) Assignee: Samsung SDI Co., Ltd., Suwon-si (KR)

(21) Appl. No.: 10/820,762

(22) Filed: Apr. 9, 2004

(30) Foreign Application Priority Data
Apr. 17, 2003 (KR) 2003-24427

(51) Int. Cl. H01M 2/16; H01M 4/40; B05D 5/12

(52) U.S. Cl. 429/137; 429/246; 429/231.95; 427/123

(57) ABSTRACT

A negative electrode of a lithium battery includes a lithium metal and a protective layer that includes a material having an ion conductivity of at least 5×10⁻⁵ S/cm. The protective layer includes ion conductive material that has a dense internal structure and an effective adhesive strength to the lithium metal. Although the protective layer has a thickness in the order of micrometers, the protective layer does not cause resistance to the electrochemical reaction and is chemically stable with respect to both the lithium metal and the electrolyte.

### CROSS-REFERENCE TO RELATED APPLICATIONS

This application claims priority to Korean patent application No. 2003-24427 filed in the Korean Intellectual Property Office on Apr. 17, 2003, the disclosure of which is incorporated herein by reference.

### BACKGROUND OF THE INVENTION

1. Field of the Invention

The present invention relates to a negative electrode for a lithium battery, a method of preparing the same, and a lithium battery comprising the same, and particularly, to a negative electrode for a lithium battery comprising a protective layer having improved lithium ion conductivity, a method of preparing the same, and a lithium battery comprising the same.

2. Description of the Related Art

The remarkable development of smaller, lighter, and higher capability electronic devices and communication devices has led to an increase in the demand for improving the performance and the capacity of secondary batteries for them. The battery generates power using materials that participate in electrochemical reactions as a positive electrode and a negative electrode. The performance such as in the capacity, the cycle life, the electric energy, the safety, and the confidence of the battery are determined depending upon the active materials. Accordingly, improvements in the electrochemical characteristics of the positive and the negative active materials have been actively studied.

Among the recently used active materials for batteries, lithium is more attractive since it has a high electric capacity per weight unit and a high electro-negativity. Accordingly, a battery may be provided with a high capacity and a high voltage upon using the lithium active material. In addition, when a negative active material is composed of the lithium metal, the lithium metal may act as a current collector as well as the active material. Thus, an additional current collector is not required to fabricate a negative electrode plate. Further, the negative electrode plate may be fabricated by depositing the lithium on a metal foil at a certain thickness or compressing a lithium foil on a sheet-shaped current collector of a metal foil or an Exmet (expanded metal). It may also be fabricated by depositing the metal on a polymer film and then either attaching the lithium foil thereto or depositing the lithium metal.

However, the lithium metal has disadvantages in that it lacks safety and tends to generate side reactions with the electrolyte of lithium metal so that dendrites are generated. In addition, the lithium is excessively required by as much as four or five times the amount of the positive active materials in order to prolong the cycle life.

Accordingly, a protective layer has recently been suggested to protect a surface of the lithium metal. The most attractive candidate is a lithium ion conductor of LIPON (Lithium Phosphorus Oxy-Nitride). In this case, since the protective layer is obtained by sputtering directly on the surface of the lithium metal under a nitrogen gas atmosphere, the nitrogen gas and Li₃PO₄ target material may react with the lithium metal to generate an adduct of a porous black lithium composite compound having poor adhesion to the lithium metal.

Since LIPON, in a similar fashion to the conventional protective layer, has a very low lithium ion conductivity (about 2×10⁻⁶ S/cm or less at room temperature), it may cause problems in that a highly significant amount of resistance to the electrochemical reaction is generated upon increasing the deposition to a thickness of more than about 2000 Å.

### SUMMARY OF THE INVENTION

It is an aspect of the present invention to provide a negative electrode for a lithium battery comprising a protective layer having effective lithium ion conductivity and a dense crystal structure.

It is another aspect of the present invention to provide a method of preparing a negative electrode for a lithium battery, wherein the method provides the negative electrode comprising the protective layer by an uncomplicated process.

It is still another aspect of the present invention to provide a lithium battery comprising the negative electrode.

To accomplish the above and/or other aspects, the present invention provides a negative electrode for a lithium battery comprising a lithium metal, and a protective layer formed on the lithium metal, wherein the protective layer comprises a material having an ionic conductivity of 5×10⁻⁵ S/cm or more.

The present invention further provides a method of preparing a negative electrode for a lithium battery comprising the operation of depositing lithium on a surface of lithium metal under a gas atmosphere of at least one selected from the group consisting of nitrogen, oxygen, chlorine, carbon monoxide, carbon dioxide, and sulfur dioxide to provide a protective layer, wherein the protective layer comprises a material having an ionic conductivity of 5×10⁻⁵ S/cm or more.

The present invention still further provides a lithium battery comprising the negative electrode; and a positive electrode comprising a positive active material selected from the group consisting of a lithium intercalation compound that reversibly intercalates/deintercalates lithium ions, a sulfur-based compound, and a conductive polymer.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic view showing a deposition device to prepare a protective layer of the present invention;

FIG. 2 is a perspective view showing a lithium secondary battery; and

FIG. 3 is a Scanning Electron Microscope (SEM) photograph of the protective layer prepared in accordance with an embodiment of the present invention.

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

The protective layer is to protect the lithium metal of the negative electrode from direct contact with the electrolyte. To accomplish this, the protective layer is required to have a high ionic conductivity, enough adhesive strength to adhere to the electrode, and an internal structure dense enough to prevent leaking of the liquid electrolyte. The protective layer is also required to have a mechanical strength sufficient to bear physical variations on the surface of the electrode. Among these factors, it is considered that the high ionic conductivity and the dense internal structure are the most critical factors. Having the high ionic conductivity, it is possible to provide a battery with a thick film of approximately micrometer level without generating resistance to the electrochemical reaction. In addition, having a dense internal structure, it is substantially possible to prevent permeation by the electrolyte.

According to the present invention, the protective layer is composed of a material having an ionic conductivity of 5×10⁻⁵ S/cm or more, generally 1×10⁻⁴ S/cm or more, and more desirably 1×10⁻³ S/cm or more. Since the protective layer of the present invention has a high ionic conductivity, although the protective layer has a thickness in the order of micrometers, it does not cause the resistance to the electrochemical reaction, and it is chemically stable with respect to both the lithium metal and the electrolyte. In addition, the material composing the protective layer is in crystalline phases and has a dense internal structure so that it easily prevents permeation of the liquid electrolyte, and the protective layer has an effective adhesive strength to the lithium metal.

The protective layer may be composed of a material such as an oxide, nitride, oxynitride, sulfide, oxysulfide, and halonitride. The specific examples thereof may include Li₃N, LiAlCl₄, Li₉N₂Cl₃, Li₉₋ₓNaₓN₂Cl₃, Li₉₋ₓKₓN₂Cl₃, Li₉₋ₓRbₓN₂Cl₃, Li₉₋ₓCsₓN₂Cl₃, 3Li₃N—Lil, 3Li₃N—Nal, 3Li₃N—Kl, 3Li₃N—Rbl, and the like, wherein 0<x<9. The Li₃N has a high ionic conductivity of 1×10⁻⁴ S/cm, and the remaining materials have ionic conductivity of between 5×10⁻⁵ and 1×10⁻⁴. The ionic conductivity is a value measured at a room temperature.

According to the present invention, the thickness of the protective layer is typically between 500 Å and 5 μm. When the thickness of the protective layer is less than 500 Å, the electrode cannot withstand the variations of the thickness and the surface roughness under an excessively large amount of current, such that it is oxidized/reduced so the electrode may be broken. On the other hand, when the protective layer is more than 5 μm, the energy density is decreased due to the increased volume (thickness) of the electrode.

The protective layer generally has an average surface roughness of 5000 Å or less. When the average surface roughness is more than 5000 Å, the current may be partially concentrated to cause destruction of the protective layer and shortening of the cycle life.

The protective layer of the present invention may further comprise lithium oxide (Li₂O). The lithium oxide may be added in amounts of 10% by weight, generally between 1 and 5% by weight based on the total weight of the protective layer. When the amount of the lithium oxide is more than 10% by weight, it is not desirable since the lithium ion conductivity may be degraded dramatically.

The protective layer may be prepared by depositing lithium on the surface of the lithium metal under an atmosphere of at least one reaction gas selected from the group consisting of nitrogen, oxygen, chlorine, carbon monoxide, carbon dioxide, and sulfur dioxide. The lithium metal may include, but is not limited to, a lithium foil or lithium deposited on a resin film base material or a metal-deposited resin film base material (for example: copper-deposited polyethylene terephthalate film). The lithium source used for depositing lithium may be any conventional lithium metal foil. The lithium deposition process is typically performed by thermal deposition under a vacuum atmosphere of 2˜3×10⁻⁶ Torr.

The protective layer composing various materials may be prepared by adjusting the composition and amount of the reaction gas. The argon gas may be added to the reaction gas to increase the ionization efficiency. For example, to obtain an Li₃N protective layer, the nitrogen gas is generally mixed with argon gas in a volume ratio of between 5:1 and 9:1.

The deposition process may be performed by any conventional method to deposit the lithium ion conductive material on the lithium metal, and representative examples thereof may include sputtering, ion beam sputtering, electron beam evaporation, vacuum thermal evaporation, laser ablation, chemical vapor deposition, thermal evaporation, plasma chemical vapor deposition, laser chemical vapor deposition, and jet vapor deposition.

In an embodiment of the present invention, the densely structured protective layer is obtained by depositing the lithium and accelerating the ion beam at the same time. That is, under the atmosphere of at least one reaction gas selected from the group consisting of nitrogen, oxygen, chlorine, carbon monoxide, carbon dioxide, and sulfur dioxide, the lithium metal is subjected to the deposition and the ion beam irradiation at the same time so that the reaction gas is converted into an ion phase to deposit together with the lithium on the protective layer. The resultant protective layer has a crystalline structure having no pores therein. The ion beam is generally accelerated at a rate of between 50 eV and 200 eV.

The lithium deposition may be carried out by heat evaporation or electron beam evaporation, and the ion beam may be accelerated by an ion gun or a plasma source. The structural features of the protective layer are easily controlled by adjusting the ion beam energy. FIG. 1 is a schematic view showing the device for preparing the protective layer using ion beam acceleration. The device comprises a unit to evaporate the lithium 10, a unit to accelerate the ion beam 20, and a substrate 30, and may further comprise a cooler to control the elevated temperature (not shown), a unit to exhaust gas 40, and the like. The resultant protective layer has a very dense crystalline structure so that a further process such as heat treatment is not required.

The present invention further provides a lithium battery comprising the negative electrode having the protective layer, and a positive electrode comprising a positive active material. Embodiments of the lithium battery may include, but are not limited to, a lithium thin film battery, a lithium-sulfur secondary battery, and the like. The positive active material may include, but is not limited to, a lithium interaction compound to intercalate/deintercalate the lithium ions reversibly, a sulfur-based material, and the like.

The lithium intercalation compound to intercalate/deintercalate the lithium ions reversibly may include a lithium composite metal oxide or lithium-included chalcogenide compound, which are well known in the lithium battery field. The sulfur-based material may include elemental sulfur (S₈), Li₂Sₙ(n≧1), an organosulfur compound, a carbon-sulfur polymer ((C₂Sₓ)ₙ: x=2.5˜50, n≧2), and the like. The lithium battery of the present invention may further comprise a separator and an electrolyte consisting of an electrolyte salt and an organic solvent. Needless to say, the lithium battery of the present invention may comprise any conventional electrolyte and separator.

For example, the electrolyte salt may include a lithium salt as used in the conventional lithium-sulfur secondary battery. The lithium salt may be exemplified by LiPF₆, LiBF₄, LiSbF₆, LiAsF₆, LiClO₄, LiCF₃SO₃, Li(CF₃SO₂)₂N, LiC₄F₉SO₃, LiSbF₆, LiAlO₄, LiAlCl₄, LiN(CₓF₂ₓ₊₁SO₂) (C_{y}F_{2y+1}SO₂) (wherein x and y are natural numbers), LiCl, Lil, and the like. The concentration of the lithium salt is typically between 0.6 and 2.0 M, and more desirably, between 0.7 and 1.6 M. When the concentration of the lithium salt is less than 0.6 M, the conductivity of the electrolyte is reduced, reducing the capability of the battery. On the other hand, when the concentration is more than 2.0 M, the viscosity of the electrolyte is increased so that it is hard to transmit the lithium ions.

The organic solvent may be a single solvent or a mixture of two or more organic solvents. If the organic solvent is a mixture of two or more organic solvents, at least one solvent is generally selected from at least two groups of a weak polar solvent group, a strong polar solvent group, and a lithium metal protection solvent group.

The term “weak polar solvent,” as used herein, refers to a solvent that is capable of dissolving elemental sulfur, and that has a dielectric coefficient of less than 15. The weak polar solvent may include aryl compounds, bicyclic ether, and acyclic carbonate compounds. The term “strong polar solvent,” as used herein, refers to a solvent that may dissolve lithium polysulfide, and that has a dielectric coefficient of more than 15. The strong polar solvent may include bicyclic carbonate compounds, sulfoxide compounds, lactone compounds, ketone compounds, ester compounds, sulfate compounds, or sulfite compounds. The term “lithium protection solvent,” as used herein, refers to a solvent which forms an effective protective layer, i.e. a stable solid-electrolyte interface (SEI) layer on the lithium surface, and which shows an effective cyclic efficiency of at least 50%. The lithium protection solvent is selected from saturated ether compounds; unsaturated ether compounds; or heterocyclic compounds including N, O, S; and a composite thereof.

Examples of the weak polar solvents include xylene, dimethoxyethane, 2-methyltetrahydrofurane, diethyl carbonate, dimethyl carbonate, toluene, dimethyl ether, diethyl ether, diglyme, or tetraglyme.

Examples of the strong polar solvents include hexamethyl phosphoric triamide, [symbol] -butyrolactone, acetonitrile, ethylene carbonate, propylene carbonate, N-methylpyrrolidone, 3-methyl-2-oxazolidone, dimethyl formamide, sulfolane, dimethyl acetamide, dimethyl sulfoxide, dimethyl sulfate, ethylene glycol diacetate, dimethyl sulfite, or ethylene glycol sulfite.

Examples of the lithium protection solvents include tetrahydrofuran, ethylene oxide, dioxolane, 3,5-dimethylisoxazole, 2,5-dimethyl furan, furan, 2-methyl furan, 1,4-oxane, and 4-methyldioxolane.

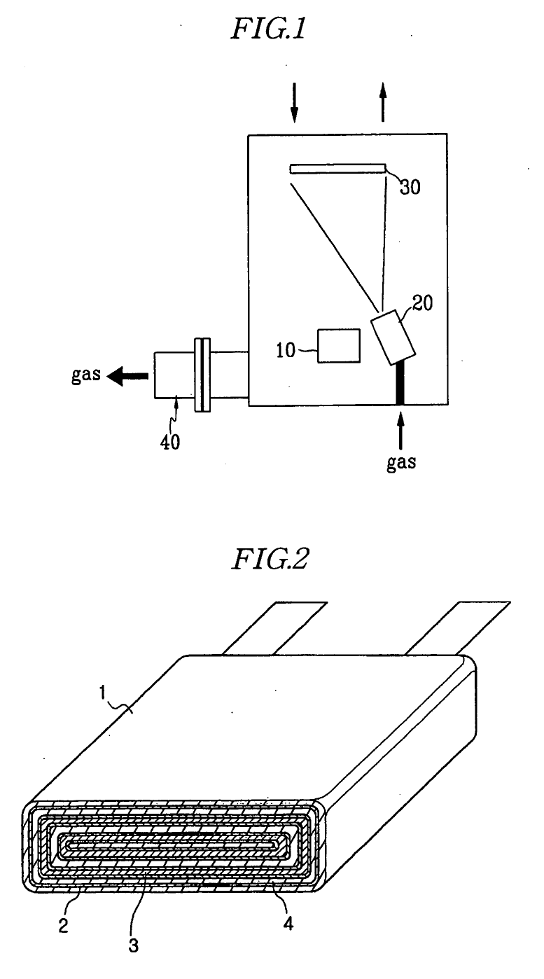

The structure of the lithium battery is also known to those skilled in the art. FIG. 2 shows an embodiment of the structure of the lithium secondary battery 1 of the present invention. As shown in FIG. 2, a positive electrode 3, a negative electrode 4, and a separator 2 interposed between the positive electrode 3 and the negative electrode 4 are inserted in a battery case.

Hereinafter, the present invention will be explained in detail with reference to examples. These examples, however, should not in any sense be interpreted as limiting the scope of the present invention.

### EXAMPLE 1

A lithium metal foil as a deposition source was subjected to thermal deposition on a copper-deposited polyethylene terephthalate under a vacuum atmosphere of 2˜3×10⁻6 Torr so that the lithium was deposited at about a 20 μm thickness. Using 99.9999% nitrogen gas, the reaction was carried out under the pressure of 10 Torr for 30 minutes to provide a negative electrode having a lithium nitride protective layer of a 1 μm thickness.

### EXAMPLE 2

Using the deposition device shown in FIG. 1, a copper-deposited polyethylene terephthalate film was placed on a substrate holder. By using a lithium metal foil as a deposition source, the thermal deposition was carried out under a vacuum atmosphere of 2˜3×10⁻⁶ Torr to deposit the lithium at approximately a 20 μm thickness. Then, nitrogen and argon were mixed at a ratio of 5:1˜9:1 and an ion beam having ion energy of 50˜300 eV was irradiated to the surface of the lithium using an ion gun, and concurrently the lithium was thermally deposited. The obtained negative electrode had a Li₃N crystal protective layer with a thickness of 2000 Å˜1 μm.

### COMPARATIVE EXAMPLE 1

A lithium metal foil as a deposition source was thermally deposited on copper-deposited polyethylene terephthalate under a vacuum atmosphere of 2˜3×10⁻⁶ Torr to provide a negative electrode with the lithium deposited at a thickness of about 20 μm.

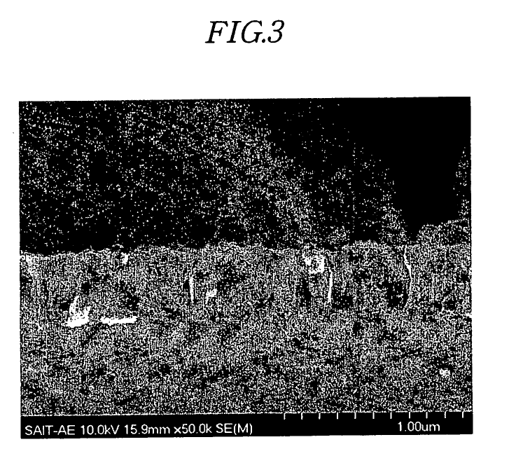

FIG. 3 shows a SEM photograph of the cross section of a negative electrode obtained from Example 2. As shown in FIG. 3, it is evident that the cross section of the obtained protective layer has a very dense structure without presenting any pores. Further, XRD (X Ray Diffraction) analysis results exhibited that the sample had a crystalline structure in which the main diffraction peak was detected and the ion conductivity was relative high, such as at 7×10⁻⁴ S/cm.

Using negative electrodes of Examples 1 and 2 and Comparative Example 1, lithium-sulfur cells were fabricated. First, 67.5% by weight of elemental sulfur, 11.4% by weight of a carbon conductor, and 21.1% by weight of a polyethylene oxide binder were mixed to provide a positive active material slurry. The slurry was coated on a carbon-coated aluminum current collector, and dried in a vacuum oven at 60° C. for at least 12 hours to provide a positive electrode plate. The positive electrode plate, vacuum-dried separator, and negative electrode of any one of Examples 1 and 2 and Comparative Example 1 were placed on this order and introduced into a pouch. Then an electrolyte solution was inserted into the pouch. The electrolyte was a solution in which 1 M LiN(SO₂CF₃)₂ was dissolved in a solvent of dimethoxyethane/dioxolane at a volume ratio of 4/1. After this, the pouch was sealed to assemble a pouch-type test cell.

The assembled test cell was charged at 0.2 C in a voltage range of 1.5 to 2.8 V, and let stand for 10 minutes, then discharged at 0.5 C and let stand for a further 10 minutes. Such charge and discharge were repeated 100 times, and the capacity retention rates are shown in the following Table 1.

TABLE 1

| | 10th cycle | 50th cycle | 100th cycle |
|---|---|---|---|
| Example 2 | 95% | 90% | 87% |
| Comparative Example 1 | 90% | 60% | 60% |

As shown in Table 1, the capacity of the cell of Example 2 at the 100th cycle was maintained at 87% relative to the initial capacity, while that of Comparative Example 1 was maintained at 60%. Accordingly, the cycle-life characteristic of Example 2 is remarkably superior to that of Comparative Example 1.

The protective layer formed on the negative electrode for the lithium battery according to the present invention is composed of an ion conductive material having a dense structure, an effective adhesive strength, and a high ionic conductivity. Due to the high ionic conductivity, the protective layer of the present invention will not cause resistance to the electrochemical reaction even if the thickness of the protection layer is in the order of micrometers, and the protective layer is chemically stable with respect to both the lithium-based electrode and the electrolyte.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A negative electrode of a lithium battery comprising a lithium metal, and a protective layer formed on the lithium metal, wherein the protective layer comprises a material having an ion conductivity greater than or equal to 5×10⁻⁵ S/cm.

2. The negative electrode of the lithium battery according to claim 1, wherein the protective layer comprises a material having the ion conductivity greater than or equal to 1×10⁻⁴ S/cm.

3. The negative electrode of the lithium battery according to claim 1, wherein the protective layer comprises a material having the ion conductivity greater than or equal to 1×10⁻³ S/cm.

4. The negative electrode of the lithium battery according to claim 1, wherein the material comprising the protective layer comprises a crystalline material.

5. The negative electrode of the lithium battery according to claim 4, wherein the material comprising the protective layer is selected from the group consisting of an oxide, nitride, oxynitride, sulfide, oxysulfide, and halonitride.

6. The negative electrode of the lithium battery according to claim 5, wherein the material comprising the protective layer is selected from the group consisting of Li₃N, LiAlCl₄, Li₉N₂Cl₃, Li₉₋ₓNaₓN₂Cl₃, Li₉₋ₓKₓN₂Cl₃, Li₉₋ₓRbₓN₂Cl₃, Li₉₋ₓCsₓN₂Cl₃, 3Li₃N—Lil, 3Li₃N—Nal, 3Li₃N—Kl, and 3Li₃N—Rbl (wherein 0<x<9).

7. The negative electrode of the lithium battery according to claim 1, wherein the protective layer has a thickness between 500 Å and 5 μm.

8. The negative electrode of the lithium battery according to claim 1, wherein the protective layer has an average surface roughness less than or equal to 5000 Å.

9. The negative electrode of the lithium battery according to claim 1, wherein the lithium metal one selected from the group consisting of a lithium foil, lithium deposited on a resin film base material and a metal-deposited resin film base material.

10. A method of preparing a negative electrode of a lithium battery, comprising:
depositing lithium on a surface of lithium metal under an atmosphere of at least one gas selected from the group consisting of nitrogen, oxygen, chlorine, carbon monoxide, carbon dioxide, and sulfur dioxide to provide a protective layer comprising a material having an ionic conductivity greater than or equal to 5×10⁻⁵ S/cm.

11. The method of preparing the negative electrode of the lithium battery according to claim 10, wherein the material comprising the protective layer is a crystalline material.

12. The method of preparing the negative electrode of the lithium battery according to claim 10, wherein the lithium deposition is carried out by a process selected from the group consisting of sputtering, ion beam sputtering, electron beam evaporation, vacuum thermal evaporation, laser ablation, chemical vapor deposition, thermal evaporation, plasma chemical vapor deposition, laser chemical vapor deposition, and jet vapor deposition.

13. The method of preparing the negative electrode of the lithium battery according to claim 10, further comprising accelerating an ion beam upon depositing the lithium.

14. The method of preparing the negative electrode of the lithium battery according to claim 10, wherein the protective layer comprises a material having the ion conductivity greater than or equal to 1×10⁻⁴ S/cm.

15. The method of preparing the negative electrode of the lithium battery according to claim 14, wherein the protective layer comprises a material having the ion conductivity greater than or equal to 1×10⁻³ S/cm.

16. The method of preparing the negative electrode of the lithium battery according to claim 10, wherein the material composing the protective material is selected from the group consisting of an oxide, nitride, oxynitride, sulfide, oxysulfide, and halonitride.

17. The method of preparing the negative electrode of the lithium battery according to claim 10, wherein the material composing the protective layer is selected from the group consisting of Li₃N, LiAlCl₄, Li₉N₂Cl₃, Li₉₋ₓNaₓN₂Cl₃, Li₉₋ₓKₓN₂Cl₃, Li₉₋ₓRbₓN₂Cl₃, Li₉₋ₓCsₓN₂Cl₃, 3Li₃N—Lil, 3Li₃N—Nal, 3Li₃N—Kl, and 3Li₃N—Rbl (wherein 0<x<9).

18. The method of preparing the negative electrode of the lithium battery according to claim 10, wherein the protective layer has a thickness between 500 Å and 5 μm.

19. The method of preparing the negative electrode of the lithium battery according to claim 10, wherein the protective layer has an average surface roughness less than or equal to 5000 Å.

20. The method of preparing the negative electrode of the lithium battery according to claim 10, wherein the lithium metal comprises one selected from the group consisting of a lithium foil, lithium deposited on a resin film base material and a metal-deposited resin film base material.

21. A lithium battery comprising a negative electrode comprising a lithium metal, and a protective layer formed on the lithium metal, wherein the protective layer comprises a material having an ion conductivity greater than or equal to 5×10⁻⁵ S/cm.

22. The lithium battery according to claim 21, wherein the lithium battery is a lithium-sulfur battery.

23. A lithium battery comprising the negative electrode prepared by depositing lithium on a surface of lithium metal under an atmosphere of at least one gas selected from the group consisting of nitrogen, oxygen, chlorine, carbon monoxide, carbon dioxide, and sulfur dioxide to provide a protective layer comprising a material having an ionic conductivity greater than or equal to 5×10⁻⁵ S/cm.

24. The lithium battery according to claim 23, wherein the lithium battery is a lithium-sulfur battery.
